(19) United States
(12) Patent Application Publication
(10) Pub. No.: US 2009/0025013 A1
(43) Pub. Date: Jan. 22, 2009

(54) INFORMATION NOTIFICATION APPARATUS, METHOD AND PROGRAM

(75) Inventor: Masanori Hattori, Kawasaki-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Kabushiki Kaisha Toshiba

(21) Appl. No.: 12/048,377

(22) Filed: Mar. 14, 2008

(30) Foreign Application Priority Data
Jul. 20, 2007 (JP) 2007-189795

(51) Int. Cl. G06F 9/44

(52) U.S. Cl. 719/318

(57) ABSTRACT

An information notification apparatus includes a unit storing at least one determination rule including a determination condition and a type, the determination condition being for determining a first operation state to be executed on a computer by a user, and the type indicating one type of information notification corresponding to the determination condition, a unit acquiring a second operation state as operation state information, an information notification unit executing information notification corresponding to the determination condition to notify the user about the executed information notification if the second operation state matches the determination condition, and a unit registering a temporary determination rule including the second operation state and a corresponding type to the second operation state if the temporary determination rule fails to match the determination rule, and registering the temporary determination rule as a new determination rule if the temporary determination rule is used more than a threshold value.

### CROSS-REFERENCE TO RELATED APPLICATIONS

This application is based upon and claims the benefit of priority from prior Japanese Patent Application No. 2007-189795, filed Jul. 20, 2007, the entire contents of which are incorporated herein by reference.

### BACKGROUND OF THE INVENTION

1. Field of the Invention

The present invention relates to an information notification apparatus, method, and program which notify a user who is operating an information device such as a PC or portable phone of arrival of new information such as e-mail which occurs asynchronously with the user's operation state.

2. Description of the Related Art

Conventional e-mail client software such as Outlook Express® or Thunderbird® automatically executes a new mail arrival confirmation process for a user or requires the user to manually execute it.

In manual confirmation, a user manually executes the mail reception confirmation function of the mail client software by himself/herself. Then, the mail client software executes the new mail arrival confirmation process for a mail server. If newly arrived mail exists, the mail client notifies the user of it on the screen.

In automatic confirmation, mail client software automatically executes the new mail arrival confirmation process at a predetermined time interval, thereby implementing the function of notifying a user of new mail reception.

There is also proposed a method of automatically notifying a user of mail arrival by introducing a notification method in accordance with the urgency or importance of the contents of each mail for the user, instead of doing the above-described automatic notification at a predetermined time interval (e.g., JP-A 10-283291 [KOKAI]). Another proposed method implements mail accumulation and batch delivery by a delivery instruction means for switching permission/inhibition of mail delivery (e.g., JP-A 06-90249 [KOKAI]

However, in the automatic confirmation and notification at a predetermined time interval, the notification timing does not at all reflect the user's operation state at that time. The asynchronously executed information notification can divert user's attention away from the current operation, and the operation productivity can be degraded by, e.g., interruption of the operation.

In the notification control method based on the importance or urgency of mail contents, a user is notified preferentially of information important for him/her. However, the notification timing does not reflect the user's operation state at that time, as in the above-described case. It is therefore impossible to avoid the influence on the operation that is being executed by the user.

In the method of causing a user to manually execute the reception confirmation operation and the method of setting switching between batch delivery and individual delivery, determination of the information notification timing is left to the user. If the user forgets, information notification remains pending for a long time, and the real-timeness of information is lost. Additionally, the user needs to be conscious of notification timing determination and therefore cannot concentrate on individual operations.

### BRIEF SUMMARY OF THE INVENTION

In accordance with an aspect of the invention, there is provided an information notification apparatus comprising: a storage unit configured to store at least one determination rule including a determination condition and a type, the determination condition being for determining a first operation state of an operation to be executed on a computer by a user, and the type indicating one type of information notification corresponding to the determination condition; an acquisition unit configured to acquire a second operation state of the operation as operation state information; an information notification unit configured to execute information notification corresponding to the determination condition to notify the user about the executed information notification if the second operation state matches the determination condition; and a registration unit configured to register, in the storage unit, a temporary determination rule including the second operation state and a corresponding type to the second operation state if the temporary determination rule fails to match the determination rule stored in the storage unit, and register, in the storage unit, the temporary determination rule as a new determination rule if the temporary determination rule is used more than a threshold value.

### BRIEF DESCRIPTION OF THE SEVERAL VIEWS OF THE DRAWING

FIG. 1 is a block diagram of an information notification apparatus according to the embodiment;

FIG. 2 is a flowchart illustrating an example of the operation of the information notification apparatus in FIG. 1;

FIG. 3 is a view showing examples of notification timing determination rules stored in a notification timing determination rule management unit in FIG. 1; and

FIG. 4 is a flowchart illustrating an example of the operation of a notification timing determination rule update unit in FIG. 1.

### DETAILED DESCRIPTION OF THE INVENTION

An information notification apparatus, method, and program according to the embodiment of will be described below in detail with reference to the accompanying drawing. In the following embodiment, the same reference numbers denote parts that perform the same operations, and a description thereof will not be repeated.

The information notification apparatus, method, and program of the embodiment enable information notification while minimizing impediments to a user's operation.

In notifying a user of information such as e-mail arrival which occurs asynchronously with the user's operation state, the information notification apparatus of this embodiment grasps the user's operation state and controls the information notification timing based on the operation state, thereby notifying him/her of the new information. In other words, the information notification apparatus of this embodiment monitors a user's device operation and operation state on an information device with an e-mail reception means and browsing means, determines the notification timing without impediments to the operation that is being executed by the user, and executes the new message confirmation process and notification process at this timing.

The information notification apparatus according to this embodiment is applicable to a general computer including a control device such as a CPU, storage devices such as a ROM and RAM, an external storage device such as an HDD, a display device such as a display unit, and input devices such as a keyboard and mouse. However, the embodiment is not limited to this.

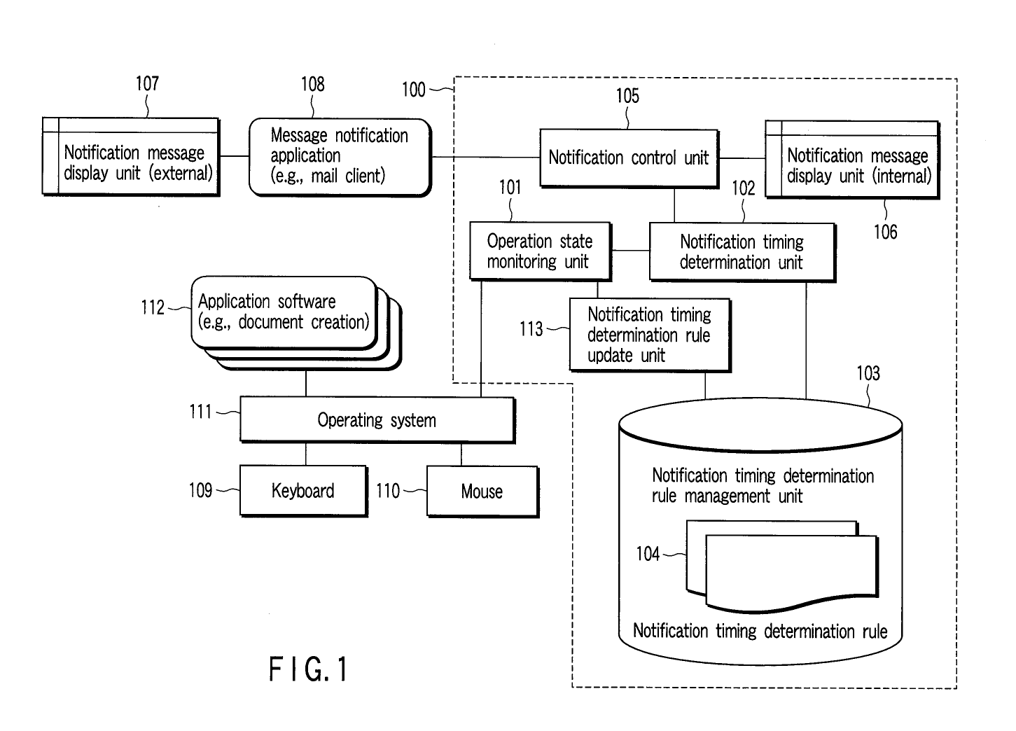

The information notification apparatus of this embodiment will be described with reference to FIG. 1.

An information notification apparatus 100 of this embodiment includes an operation state monitoring unit 101, notification timing determination unit 102, notification timing determination rule management unit 103 that stores notification timing determination rules 104, notification control unit 105, notification message display unit 106, and notification timing determination rule update unit 113. The data structure and process sequence of each functional block will be described later as needed.

The operation state monitoring unit 101 acquires, as operation state information, the operation state of an operation that is being executed on a computer by a user. The operation state monitoring unit 101 monitors the user's operation state in real time by acquiring the data of the user's operations on a keyboard 109, mouse 110, and various kinds of application software 112 from, e.g., an external operating system 111.

The notification timing determination unit 102 determines the timing of executing the new mail reception confirmation process and notification process for the user by determining the notification timing determination rule 104 on the basis of the data acquired from the operation state monitoring unit 101. In other words, if the operation state acquired by the operation state monitoring unit 101 matches a determination condition stored in the notification timing determination rule management unit 103, the notification timing determination unit 102 executes information notification corresponding to the determination condition.

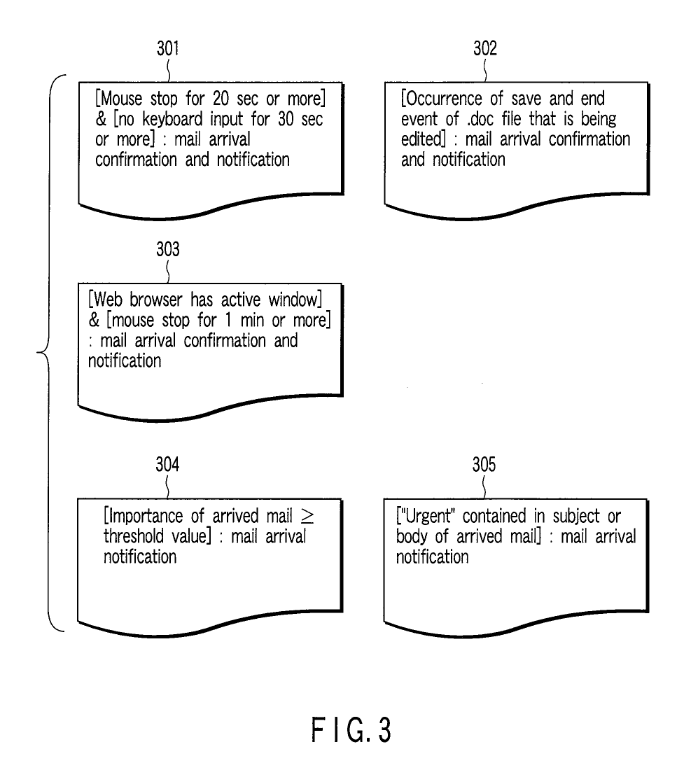

The notification timing determination rule management unit 103 stores and saves the group of notification timing determination rules 104. More specifically, the notification timing determination rule management unit 103 stores in advance at least one determination rule including a determination condition of the operation state of an operation to be executed on the computer by the user and a type of information notification to be executed when the determination condition is satisfied. Each notification timing determination rule 104 defines and describes the determination condition of the notification timing evaluated by the notification timing determination unit 102. The notification timing determination rule 104 is defined by describing the condition values of various kinds of operation state data of the user, which are acquired by the operation state monitoring unit 101 and updated by the notification timing determination rule update unit 113. New notification timing determination rules 104 can be added any time even during the operation of the information notification apparatus 100. New notification timing determination rules can be acquired by causing the user himself/herself to manually define them or causing a third party to supply them as a standard rule group. The notification timing determination rules 104 will be described later with reference to FIG. 3. The notification timing determination rule management unit 103 can be formed by any kind of generally used storage means such as an HDD, optical disk, memory card, or RAM.

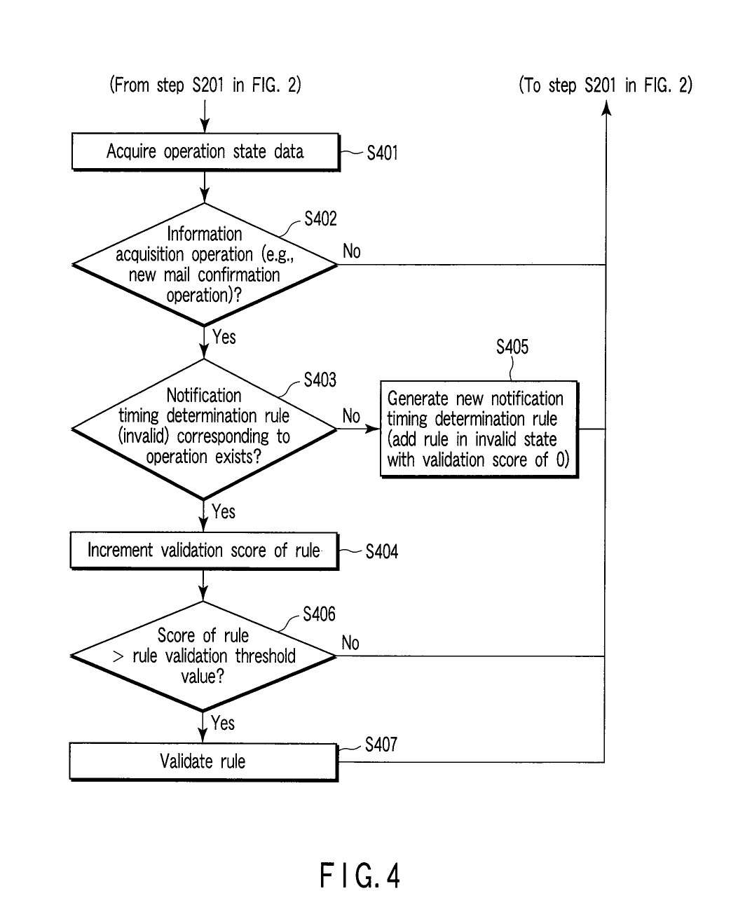

The notification timing determination rule update unit 113 acquires, from the operation state monitoring unit 101, information representing that the user has manually performed the newly arrived information reception confirmation operation. If the user frequently performs the same manual operation, the operation is added as a new notification timing determination rule to automate the manual operation. In other words, if the user's operation state and the corresponding type of information notification do not match any determination rule stored in the notification timing determination rule management unit 103, the notification timing determination rule update unit 113 registers a temporary determination rule in the notification timing determination rule management unit 103. If the temporary determination rule is used more than a threshold value, it is registered in the notification timing determination rule management unit 103 as a new determination rule. The operation of the notification timing determination rule update unit 113 will be described later with reference to FIG. 4.

When a notification timing determination condition is satisfied, i.e., when the notification timing determination unit 102 determines to execute notification, the notification control unit 105 requests an external application (e-mail client apparatus or instant message apparatus) for processing e-mail as an actual target in this embodiment to execute the new arrival confirmation process and notification process. In other words, if execution of information notification is determined, the notification control unit 105 instructs a corresponding application to notify the user of a process corresponding to the information notification and receives a corresponding notification from the application.

The notification message display unit 106 executes, in the information notification apparatus 100, presentation of a notification message about new e-mail reception externally acquired by the notification control unit 105 to the user. The information notification apparatus 100 can execute this process even without the notification message display unit 106, and the actual effect does not change depending on the presence/absence of the notification message display unit 106. The notification message display unit 106 can present the notification message to the user by using screen display, both screen display and sound generation, or only sound generation without display.

A notification message display unit 107 displays a notification message depending on an external application. The notification message display unit 107 can present the notification message to the user by using screen display, both screen display and sound generation, or only sound generation without display, like the notification message display unit 106.

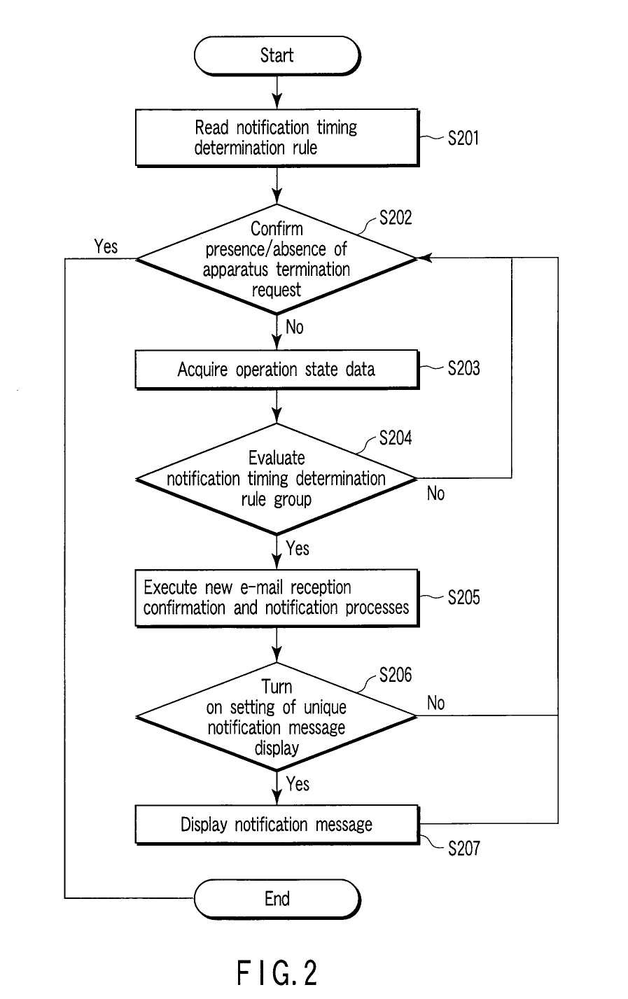

An example of the operation of the information notification apparatus 100 in FIG. 1 will be described next with reference to FIG. 2. FIG. 2 illustrates the sequence of the overall process of executing new e-mail arrival notification in consideration of the user's operation state.

As the activation of the apparatus starts, the notification timing determination unit 102 reads the notification timing determination rule group 104 from the notification timing determination rule management unit 103 (step S201). The process advances to a state capable of executing a notification timing determination rule evaluation process. The notification control unit 105 determines whether the user is going to power off the information notification apparatus (step S202).

The operation state monitoring unit 101 acquires data managed in the operating system 111, i.e., the operation event data of hardware such as the keyboard 109 and mouse 110 which are directly operated by the user, and the operation state data of the various kinds of application software 112 such as document creation software and Web browser, via the operating system 111 (step S203).

The notification timing determination unit 102 evaluates the group of notification timing determination rules 104 on the basis of the user's operation state data obtained from the operation state monitoring unit 101 (step S204). The notification timing determination rules 104 will be described later with reference to FIG. 3.

In the process of determining the group of notification timing determination rules 104 by the notification timing determination unit 102, if the conditions of one or a plurality of notification timing determination rules are satisfied, the notification timing determination unit 102 determines that point of time as the timing of executing the notification process for the user. The notification control unit 105 requests an external mail client application to execute the actual e-mail reception confirmation process and notification process (step S205). If none of the conditions of all notification timing determination rules 104 are satisfied, the process returns to step S202 without executing the e-mail reception process and notification process, and the operation state data acquisition process is executed.

In the new e-mail reception process and notification process of this embodiment, if new e-mail exists, a general mail client application generally executes a screen display process of notifying the user of it in addition to the new e-mail reception confirmation process. In this case, the notification control unit 105 sends, to the notification timing determination unit 102, a notification representing the existence of new e-mail.

In this embodiment, the information notification apparatus 100 also incorporates the notification message display unit 106 so that new e-mail arrival notification can be done separately from notification display on a separate mail client application. The user can set on/off of the unique message display process. Only when the setting is on, the notification message display unit 106 displays a unique notification window (steps S206 and S207).

If the user does not find the new e-mail reception notification on the normal mail client application inconvenient, the display function can be turned off so that the effect by this apparatus can be obtained without using the notification window unique to the information notification apparatus 100 (step S206). When the user or external device issues a termination request of the information notification apparatus 100, the operation of the apparatus is ended (step S202).

Examples of the notification timing determination rule 104 will be described next with reference to FIG. 3.

The notification timing determination rule 104 is information that defines a criterion to determine the information notification timing (in this embodiment, the timing of executing new e-mail reception confirmation and notification) for the user on the basis of various kinds of operation data which are related to user's real-time operation states and acquired by the operation state monitoring unit 101.

A notification timing determination rule example 301 uses, as a determination condition, data representing the state of a hardware operation by the user. The condition of this rule is satisfied when no mouse operation event occurs for 20 sec or more, and no keyboard input event occurs for 30 sec or more. The time without these events is counted by, e.g., a counter (not shown) incorporated in the operation state monitoring unit 101.

A notification timing determination rule example 302 uses, as a determination condition, not hardware operation state data but data representing the operation state of application software. The condition of this rule is satisfied when the user who is editing a “.doc” file using document creation software saves the file and then ends the application, i.e., when it is determined that the editing operation of a specific file finishes. The operation state monitoring unit 101 receives an event signal representing the end of the editing operation.

A notification timing determination rule example 303 defines a determination rule by combining hardware operation state data and data representing the operation state of application software. The condition of this rule is satisfied when a window of a Web browser is active, and the mouse operation stops for 1 minute or more.

A notification timing determination rule example 304 uses data representing the internal state of application software. The condition of this rule is satisfied when importance information of newly arrived e-mail held by an e-mail client application is referred, and the importance is more than a threshold value, i.e., e-mail with high importance has arrived. For example, the operation state monitoring unit 101 determines the contents of mail and adds importance information. More specifically, for example, the operation state monitoring unit 101 refers to the mail sender and determines whether the sender is important. The operation state monitoring unit 101 holds, e.g., an important sender list in advance and determines whether the sender is in the list, thereby determining whether the sender is important.

A notification timing determination rule example 305 is defined such that the condition is satisfied when the subject and body information in the text region of a newly arrived e-mail held by an e-mail client application are referred, and the body contains a specific word (“urgent” in this case).

A determination rule may be prepared to inhibit unnecessary mail from satisfying the condition. For example, whether e-mail is spam mail is determined by a known method. If it is spam mail, notification can be inhibited because the condition is not satisfied.

An example of the operation of the notification timing determination rule update unit 113 will be described next with reference to FIG. 4. FIG. 4 illustrates the sequence of an operation of adding a new notification timing determination rule or updating a rule, which is executed by the notification timing determination rule update unit 113.

The notification timing determination rule update unit 113 operates in parallel to the notification timing determination process (FIG. 2) by the notification timing determination unit 102. The notification timing determination rule update unit 113 acquires a user's operation state provided by the operation state monitoring unit 101 (step S401) and determines whether the operation state information indicates a new information arrival confirmation process (in this embodiment, the new mail reception confirmation process) by the user's manual operation (step S402).

If the determination result is true in step S402, the notification timing determination rule update unit 113 determines whether a notification timing determination rule corresponding to the same kind of operation state (e.g., execution of the new mail confirmation operation within 10 sec after the end of editing of a presentation file [“.ppt” file]) exists, and the evaluation execution flag of this rule is “invalid”, i.e., the operation is not the target of the evaluation process based on the notification timing determination rule (step S403).

If the determination result is true (if the operation is not the target of the evaluation process based on the notification timing determination rule) in step S403, the value of the validation score of the rule is incremented (step S404). It is then determined whether the validation score exceeds a predetermined threshold value (step S406).

If the determination result is true (if the validation score exceeds a predetermined threshold value) in step S406, the notification timing determination rule update unit 113 interprets that the manual confirmation process by the user frequently occurs under the same circumstances as the information notification confirmation condition described in the invalid notification timing determination rule, and changes the evaluation execution flag of the rule from “invalid” to “valid” (step S407), thereby automating the information notification confirmation process in similar cases.

If it is determined in step S402 that there is no notification timing determination rule corresponding to the manual information notification confirmation operation by the user confirmed in step S401, a new notification timing determination rule corresponding to the manual operation is generated and added to the notification timing determination rule management unit 103 (step S404). At this time, the evaluation execution flag of the newly registered rule is set to “invalid”, and the validation score is set to “0”.

According to the above-described embodiment, the new e-mail reception confirmation and notification timing is controlled on the basis of a user's operation state. It is therefore possible to implement automatic notification at a timing that minimizes impediments to the operation that is being executed by the user. This improves the productivity of various kinds of operations using an information device such as a PC.

The information notification program executed by the information notification apparatus according to this embodiment has a module structure including the above-described units. In actual hardware, the CPU reads the information notification program from a storage medium and executes it so that the above-described units are loaded to and generated on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information notification apparatus comprising:
a storage unit configured to store at least one determination rule including a determination condition and a type, the determination condition being for determining a first operation state of an operation to be executed on a computer by a user, and the type indicating one type of information notification corresponding to the determination condition;
an acquisition unit configured to acquire a second operation state of the operation as operation state information;
an information notification unit configured to execute information notification corresponding to the determination condition to notify the user about the executed information notification if the second operation state matches the determination condition; and
a registration unit configured to register, in the storage unit, a temporary determination rule including the second operation state and a corresponding type to the second operation state if the temporary determination rule fails to match the determination rule stored in the storage unit, and register, in the storage unit, the temporary determination rule as a new determination rule if the temporary determination rule is used more than a threshold value.

2. The apparatus according to claim 1, further comprising:
an instruction unit configured to, in performing information notification, instruct a corresponding application to execute a notification of a process corresponding to the executed information notification, and receive the executed notification from the application; and
a presentation unit configured to present the executed notification to the user.

3. The apparatus according to claim 1, wherein the acquisition unit acquires, as the operation state information, one of a keyboard and a mouse used by the user.

4. The apparatus according to claim 1, wherein the acquisition unit acquires, as the operation state information, application software used by the user to monitor the state.

5. The apparatus according to claim 1, wherein the information notification unit executes the executed information notification using a determination rule that defines the determination condition that is based on first operation state information of one of a keyboard and a mouse used by the user.

6. The apparatus according to claim 1, wherein the information notification unit executes the executed information notification using a determination rule that defines the determination condition that is based on second operation state information of application software used by the user.

7. The apparatus according to claim 1, wherein the information notification unit executes the executed information notification using a determination rule that defines the determination condition that is based on first operation state information of one of a keyboard and a mouse used by the user and second operation state information of application software used by the user.

8. The apparatus according to claim 2, wherein the application is an e mail client apparatus.

9. The apparatus according to claim 2, wherein the application is an instant message apparatus.

10. The apparatus according to claim 2, wherein the presentation unit displays a notification message by using a notification message display unit independently of individual applications.

11. The apparatus according to claim 2, wherein the instruction unit instructs an external application to execute a new information arrival confirmation process and new information arrival notification for the user.

12. An information notification method comprising:
storing in a storage unit at least one determination rule including a determination condition and a type, the determination condition being for determining a first operation state of an operation to be executed on a computer by a user, and the type indicating one type of information notification corresponding to the determination condition;
acquiring a second operation state of the operation as operation state information;
executing information notification corresponding to the determination condition to notify the user about the executed information notification if the second operation state matches the determination condition; and
registering, in the storage unit, a temporary determination rule including the second operation state and a corresponding type to the second operation state if the temporary determination rule fails to match the determination rule stored in the storage unit, and register, in the storage unit, the temporary determination rule as a new determination rule if the temporary determination rule is used more than a threshold value.

13. A computer readable storage medium storing instructions of a computer program which when executed by a computer results in performance of steps comprising:
storing in a storage unit at least one determination rule including a determination condition and a type, the determination condition being for determining a first operation state of an operation to be executed on a computer by a user, and the type indicating one type of information notification corresponding to the determination condition;
acquiring a second operation state of the operation as operation state information;
executing information notification corresponding to the determination condition to notify the user about the executed information notification if the second operation state matches the determination condition; and
registering, in the storage unit, a temporary determination rule including the second operation state and a corresponding type to the second operation state if the temporary determination rule fails to match the determination rule stored in the storage unit, and register, in the storage unit, the temporary determination rule as a new determination rule if the temporary determination rule is used more than a threshold value.
